(19) United States
(12) Patent Application Publication
(10) Pub. No.: US 2004/0151539 A1
(43) Pub. Date: Aug. 5, 2004

(54) Releasable snap connection

(76) Inventors: Gunter Sikora, Steyr (AT); Gerhard Sikora, Steyr (AT)

Correspondence Address: Mark D. Lorusso, Lorusso Loud & Kelly LLp, Pease International Tradeport, 15 Rye Street, Suite 312, Portsmouth, NH, 03801, US

(21) Appl. No.: 10/732,155

(22) Filed: Dec. 10, 2003

(30) Foreign Application Priority Data
Feb. 5, 2003 (AT) A 178/2003

(51) Int. Cl. F16D 1/00

(52) U.S. Cl. 403/329

(57) ABSTRACT

A releasable snap connection between an elastically resilient (2) and a preferably rigid member (3), comprising a detent element (4) having a stem (6) and a detent tip (5), and a detent receiving means (7), wherein the detent element (4) at least partially engages into the detent receiving means (7) and the detent element (4) has a sleeve (8) mounted displaceably along its stem (6) for releasing the snap connection (1).

The invention concerns a releasable snap connection between an elastically resilient and a preferably rigid member, comprising a detent element having a stem and a detent tip, and a detent receiving means, wherein the detent element at least partially engages into the detent receiving means.

DE 92 17 185 U1 discloses an apparatus for fixing a piece of equipment to a wall, in which a mounting pin engages into an elastically resilient receiving means of an article to be mounted. The illustrated mounting pin has a portion of reduced diameter, against which engage resilient limbs of the receiving means. In the illustrated apparatus, release of the snap connection is implemented by the pin being pulled out of the receiving means against the clamping force of the resilient limbs. It has been found that this known snap-action device suffers from the disadvantage that vertical use of the snap connection, as is desirable for example for mounting articles to the ceiling, is not suitable in a practical context as in general the snap connection would be released against the clamping force of the resilient limbs, by virtue of the actual weight of the article mounted to the ceiling.

Furthermore U.S. Pat. No 5,327,619 discloses a snap connection between a resilient detent element and a detent receiving means, in which the detent receiving means has means for releasing the snap connection, wherein the snap connection releasing means are so designed that the resilient detent element and the detent receiving means can be disengaged. In order to release a snap connection of that kind therefore both the detent element and also the snap connection releasing means arranged in the detent receiving means must be accessible or actuable; which besides the complicated handling involved almost excludes vertical use of the snap connection.

Taking that state of the art as the basic starting point, the object of the invention is to provide a novel snap connection which can be released in a simple manner, while avoiding the above-described disadvantages.

In accordance with the invention that is achieved in that the detent element has a sleeve mounted displaceably along its stem for releasing the snap connection. This means that the displaceable sleeve, for releasing the snap connection, can be moved into a position of releasing the resilient member with respect to the rigid member, and it remains in that position until the detent element and the detent receiving means are out of engagement.

In the snap connection according to the invention therefore the detent element which has a stem and a detent tip is introduced into the detent receiving means until the snap connection is made. To release that snap connection, subsequently only the detent element has to be further pressed into the detent receiving means in order in that way to bring the detent tip out of engagement with the detent receiving means. The displaceability of the sleeve ensures that the sleeve remains in its release position, that is to say the position in which the detent tip is out of engagement with the detent receiving means, until the detent element and the detent receiving means are out of engagement or released.

In accordance with an alternative embodiment of the invention it is provided that the one resilient member of the snap connection is formed by the detent receiving means while the other preferably rigid member of the snap connection is formed by the detent element, wherein in accordance with a preferred embodiment the detent receiving means has at least one resilient limb which is adapted for preferably positively lockingly embracing the detent tip of the detent element.

By virtue of the fact that the resilient member of the snap connection is formed by the detent receiving means, it is possible for the detent element, in particular the detent tip, to be rigid, for example in the form of a pin. In that way it is possible very substantially to avoid damage to the detent element which can be made for example from metal, wood, plastic material or the like. If the resilient limb is adapted for positively lockingly embracing the detent tip, that ensures, particularly in a situation involving vertical use of the snap connection, that the detent element or an article to be supported, which is connected to the detent element, does not by virtue of its weight unintentionally release the snap connection against the clamping force of the resilient limbs.

In order to ensure that, when the detent element is further pressed into the detent receiving means, the sleeve is moved into a position of releasing the resilient member with respect to the rigid member and does not slip back along the stem, a further embodiment of the invention provides that the stem of the detent element has a preferably annular, flange-like enlargement, wherein the sleeve is arranged between said flange-like enlargement and the detent tip displaceably on the stem. In that respect, it has proven to be particularly advantageous if the detent receiving means has at least two resilient, preferably substantially I-shaped limbs, the free ends of which are adapted for engagement between the detent tip and the flange-like enlargement.

If, on its side towards the detent tip, the sleeve is of a conically tapering configuration and/or if the free end or ends of the limb or limbs of the detent receiving means is or are bevelled, the sleeve can be more easily brought into engagement with the resilient member of the detent receiving means. It is advantageous for the same reason if the detent tip is of a conically tapered, rounded or hemispherical configuration.

A particularly simple embodiment of the invention provides that the detent receiving means is in the form of a shaped tube, preferably of rectangular cross-sectional area, and has at least one through opening extending in the longitudinal direction for the detent element or elements, wherein the wall of the tube on at least one side of the through opening has a plurality of through apertures which extend substantially normal to the through opening and which extend as far as the through opening. If therefore the snap connection is used for fixing for example coathangers or hooks or for mounting articles of everyday use or utensils such as a tool or domestic implements, only the shaped tube serving as the detent receiving means has to be fixed to the wall, the ceiling or in some other fashion, so that subsequently the articles to be supported, each of which generally has a detent element for itself, can be fixed by being simply pressed into the through opening of the shaped tube.

If the detent receiving means is mounted in a housing with a through opening for the detent element and the resilient limbs are supported on the housing with their ends which embrace the detent tip of the detent element, it is possible in that way to prevent the detent elements from automatically coming loose from the detent receiving means—even if they are connected to an article of relatively great weight, for example a clothes hook provided with an article of clothing. It has proven to be particularly advantageous in that respect if the housing is arranged displaceably in a shaped tube with a through opening extending in the longitudinal direction, whereby the articles held by means of the snap connection are freely displaceable by means of the housing in the shaped tube. Such a design configuration has proven to be useful in particular when using the invention in relation to wardrobe racks.

In accordance with a further alternative embodiment of the invention it is provided that the one resilient member of the snap connection is formed by the detent element while the other, preferably rigid member of the snap connection is formed by the detent receiving means. In this variant in which the detent element advantageously has at least two detent segments which are of a radially resilient nature, it is possible entirely to forego a particular design configuration of the detent receiving means. In accordance with a preferred embodiment of the invention it is sufficient if the detent receiving means is formed by a bore in the preferably rigid member of the snap connection, for example in a wood, metal or plastic plate or the like.

An alternative embodiment provides that the detent receiving means is in the form of a shaped tube and has at least one bore and/or at least one through opening extending in the longitudinal direction, for a resilient detent element, thereby providing for displaceability of the detent elements in the detent receiving means.

In order to ensure radial mobility of the detent segments, which must be both inwardly, that is to say relative to the longitudinal central axis of the detent element, and also outwardly—after the detent tip has passed through the detent receiving means —, a further embodiment of the invention provides that at least one detent segment includes a portion of the detent tip and a portion of the stem of the detent element. A simple structure is afforded if the sleeve also has at least two casing segments which are of a radially resilient nature, in which case the snap connection can be particularly easily released if the detent segments of the detent element and the casing segments of the sleeve are adapted for preferably positively locking engagement with each other.

Secure engagement of the detent element with the detent receiving means can be achieved if the free ends of the detent segments of the detent element and/or the free ends of the casing segments of the sleeve are of a hook-shaped configuration. In a first step therefore the detent tip of a hook-shaped configuration is brought into engagement with the detent receiving means. To release the snap connection then in a further step the sleeve or at least the hook-shaped casing segments of the sleeve is brought into engagement with the detent receiving means, whereby at the same time the detent segments of the detent element are brought out of engagement with the detent receiving means. When the detent element is pulled out of the detent receiving means the casing segments of the sleeve and the hook-shaped detent segments of the detent element engage into each other in positively locking relationship, thereby preventing fresh engagement of the detent tip with the detent receiving means.

Alternatively it would also be possible for the outer peripheral surface of the sleeve to be adapted for positively locking engagement with the detent receiving means so that, to release the snap connection, the sleeve which in this case does not necessarily have to have resilient casing segments has to be introduced only to a slight portion thereof into the detent receiving means.

Further advantages and details of the snap connection according to the invention are described in greater detail hereinafter with reference to the accompanying Figures in which:

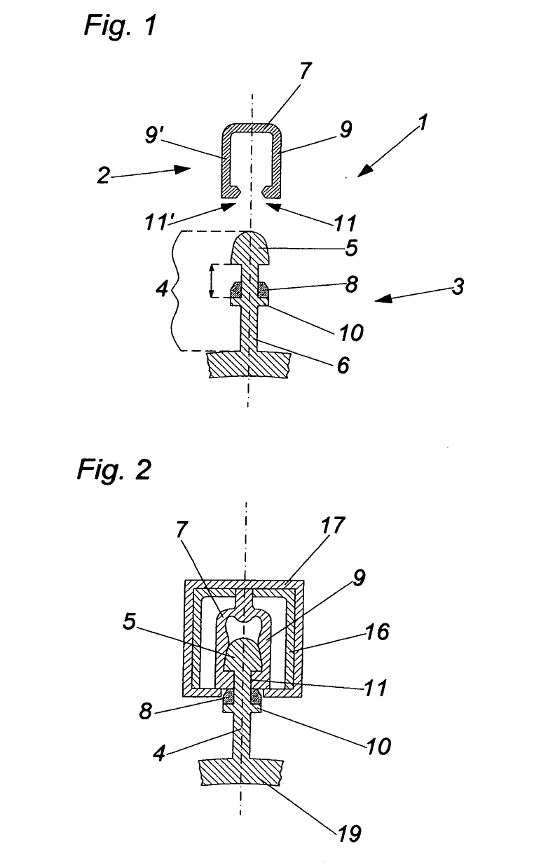

FIG. 1 shows a released snap connection with a resilient detent receiving means and a rigid detent element,

FIG. 2 is a view in cross-section through a shaped tube in which a housing is arranged, wherein disposed in the housing is a resilient detent receiving means which embraces a rigid detent element in positively locking relationship,

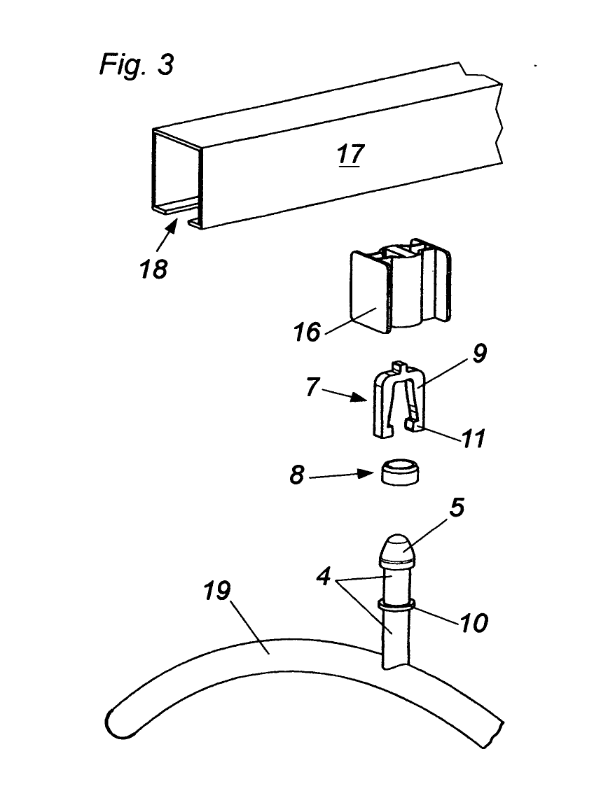

FIG. 3 shows an exploded view of the detent connection illustrated in FIG. 2,

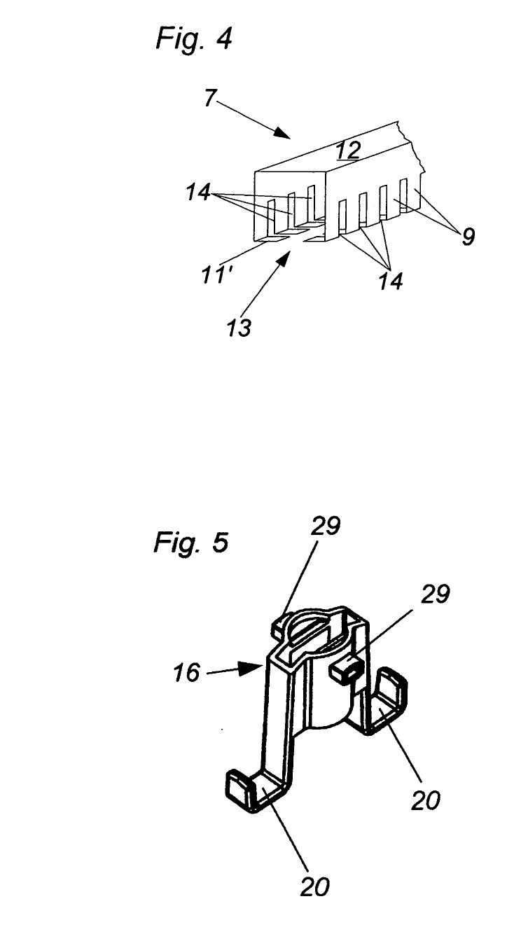

FIG. 4 shows a detent receiving means in the form of a shaped tube,

FIG. 5 shows a housing for receiving a detent receiving means,

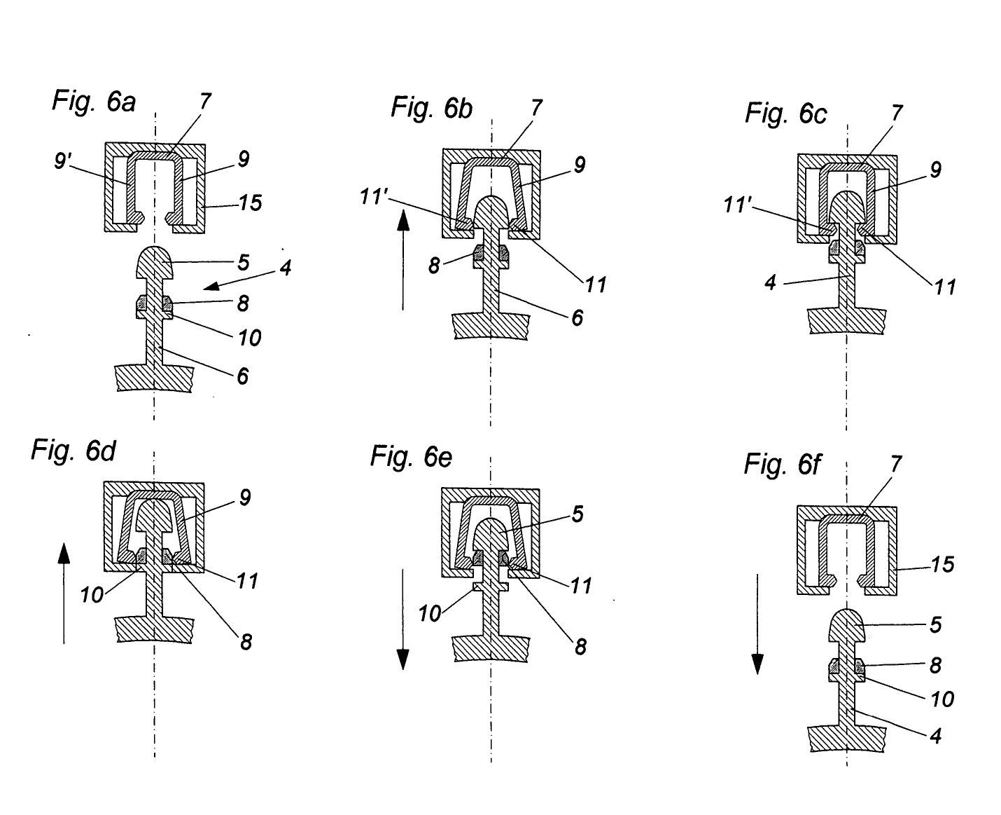

FIGS. 6a to 6f show the individual steps for making and releasing a snap connection between a detent receiving means which is of a resilient nature and which is arranged in a housing and a rigid detent element,

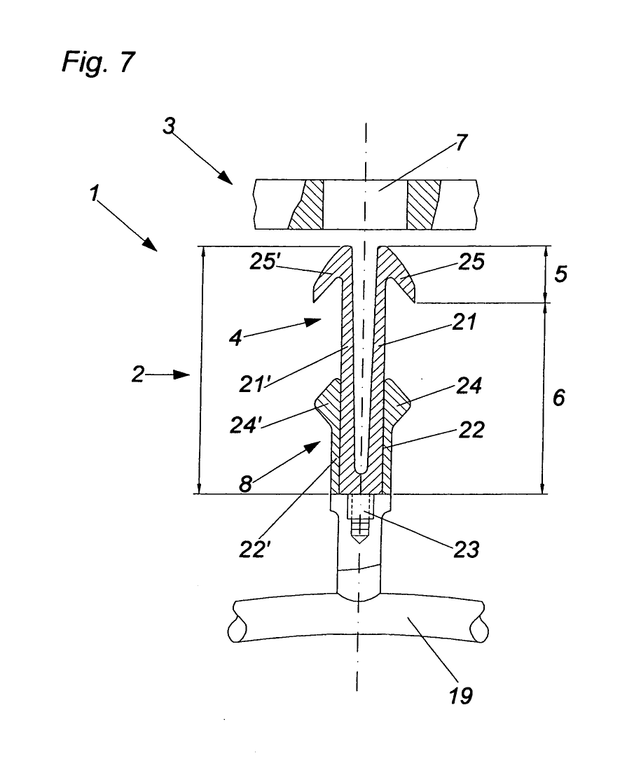

FIG. 7 shows a further alternative embodiment of the invention with a rigid detent receiving means and a resilient detent element,

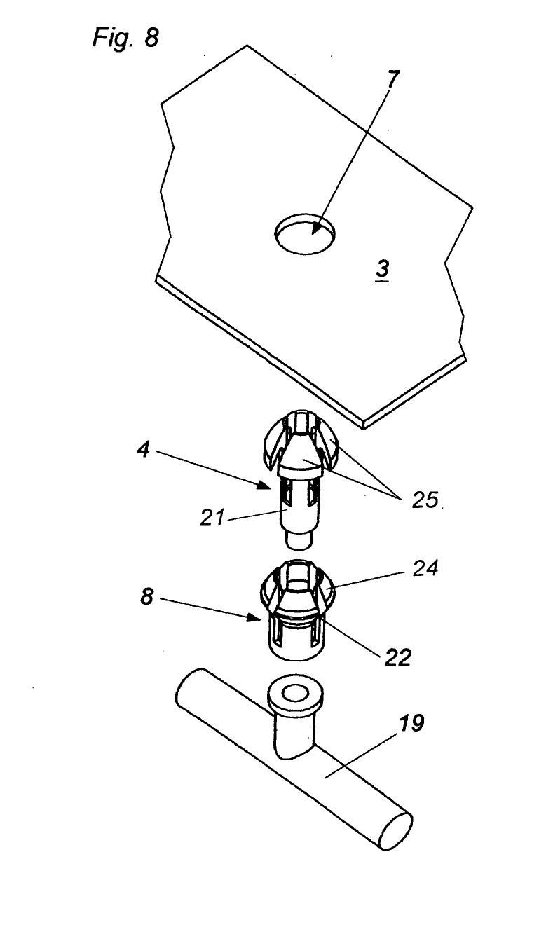

FIG. 8 shows an exploded view of the invention as shown in FIG. 7,

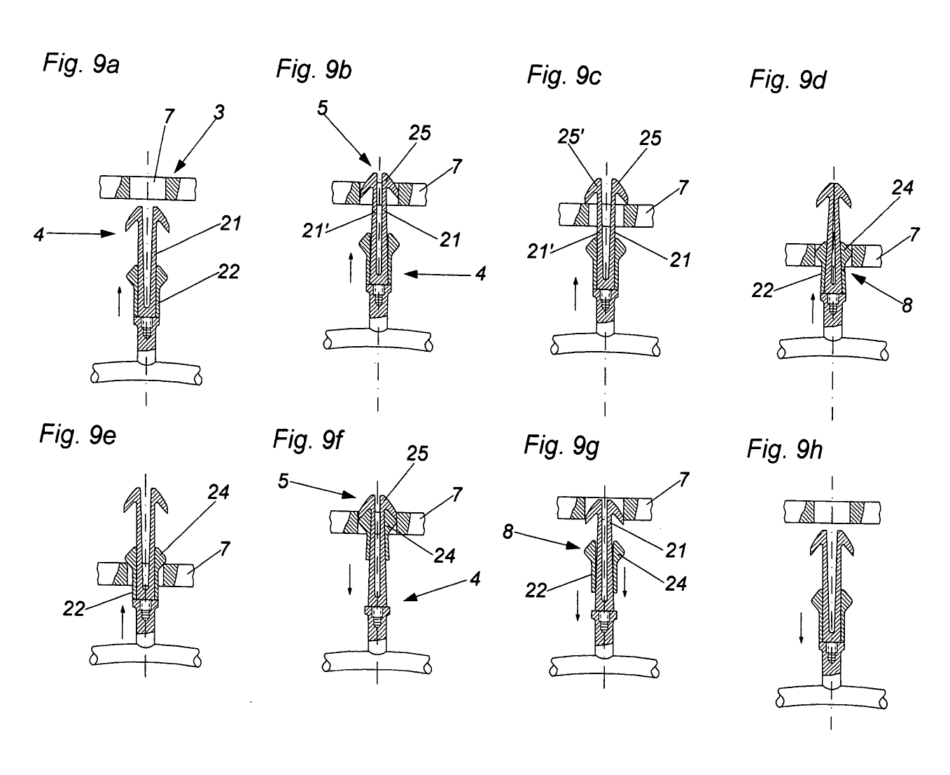

FIGS. 9a to 9h show the steps for making and releasing the snap connection according to the invention as shown in FIG. 7, and

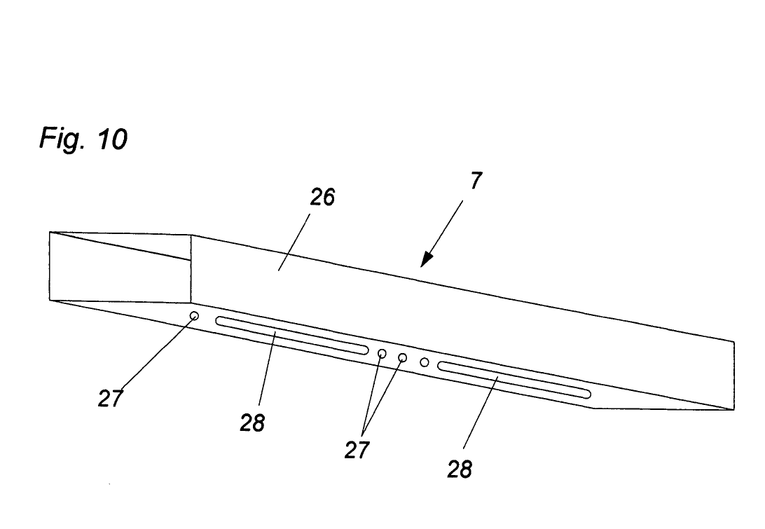

FIG. 10 shows an embodiment for a rigid detent receiving means in the form of a shaped tube.

In the case of the snap connection 1 shown in FIG. 1 the resilient member 2 is formed by the detent receiving means 7. The detent receiving means 7 which can be made for example from metal or plastic material is in the form of a U-shaped loop which has two resilient limbs 9, 9′. The free ends 11, 11′ of the resilient limbs 9, 9′, at their inward sides which face towards each other, have two wedge surfaces which are at an angle relative to each other and are adapted for positively lockingly embracing the detent tip 5 of the detent element 4. In the illustrated embodiment the detent element 4 represents the substantially rigid member 3 of the snap connection 1. Adjoining the detent tip 5 the detent element 4 has a stem 6 on which a sleeve 8 is displaceably mounted. In addition arranged on the stem 6 is a flange-like enlargement 10 which serves as an abutment for the sleeve 8. The sleeve 8 is conically tapered on its side towards the detent tip 5, whereby, when the detent element 4 is pressed into the detent receiving means 7, the free ends 11, 11′ of the resilient limbs 9, 9′ slide more easily on to the sleeve 8. For the same reason the detent tip 5 is of a hemispherical configuration.

FIG. 2 in which identical components are denoted in the same fashion shows an upright snap connection, wherein the detent receiving means 7 is arranged in a housing 16. The housing 16 in turn is again mounted displaceably in a shaped tube 17, with the resilient limbs 9, 9′ of the detent receiving means being supported against the shaped tube 17. That ensures that the detent element 4 which for example is connected to a clothes hanger 19 cannot be unintentionally released from the detent receiving means 7. Release in that manner is also prevented by virtue of the fact that the resilient limbs 9, 9′ are adapted for positively lockingly embracing the detent tip 5, in which case the free ends 11, 11′ of the resilient limbs 9, 9′ engage the stem 6 of the detent element 4 between the sleeve 8 and the detent tip 5, thus embracing the detent tip 5.

FIG. 3 shows an exploded view of the embodiment illustrated in FIG. 2, in which respect it is to be noted that the sleeve 8 is disposed between the detent tip 5 and the flange-like enlargement 10 on the stem 8 of the detent element 4. The arrangement of the detent receiving means 7 in the housing 16 which is mounted displaceably in the shaped tube 17 provides that the clothes hook 19 which is connected to the detent element 4 can be displaced in the shaped tube 17 in the longitudinal direction.

FIG. 4 shows a further embodiment in which the detent receiving means 7 is formed by a shaped tube 12. In this embodiment the shaped tube 12 has a through opening 13 which is arranged in the longitudinal direction. One or more detent elements can now be introduced into the detent receiving means 7 through the through opening 13, wherein resilient limbs 9 are provided by virtue of interruptions 14 arranged in the side wall of the shaped tube 12. Therefore, in contrast to the embodiment shown in FIG. 3 in which, before inserting a detent element 4 into the through opening 18, it is necessary to check where a housing 16 with a detent receiving means 7 is disposed, the detent element 4 on which for example a clothes hook or an article of everyday use or utensil such as a tool, domestic implements or the like are arranged, can be inserted at any location into the detent receiving means 7 which is in the form of the shaped tube 12. The interruptions not only form resilient limbs 9 in the side walls of the shaped tube 12, at the same time that arrangement also ensures that a detent element 4 which is already disposed in the detent receiving means 7 is not brought out of engagement with the detent receiving means 7 by virtue of the side walls being spread away from each other upon insertion of a detent element 4 into the shaped tube 12.

FIG. 5 shows a further embodiment for a housing 16 for receiving a detent receiving means 7 which, besides guide projections 29 which permit the housing 16 to slide reliably in the shaped tube 17, has additional hooks 20.

FIGS. 6a to 6f show the individual steps for making and releasing a snap connection according to the invention. In FIG. 6a the detent receiving means 7 is arranged in a housing 15, the resilient limbs 9, 9′ being supported against the housing 15. The detent element 4 is pressed in the direction of the arrow into the detent receiving means 7 whereby, as can be seen from FIG. 6b, the two resilient limbs are spread apart by the detent tip. At that time the sleeve 8 is still freely movable and bears against the flange-like enlargement 10 on the stem 6. In FIG. 6c the snap connection is made, with the detent tip 5 having the free ends 11, 11′ of the resilient limbs engaging therebehind, thereby making it possible to reliably prevent release of the detent element 4 from the detent receiving means 7, together with the fact that the resilient limbs 9, 9′ are supported against the housing 15.

To release the snap connection, as shown in FIG. 6d, the detent element 4 is pushed further into the receiving means 7, whereby the resilient limbs 9 are spread apart by the sleeve 8 and engage at the peripheral surface of the sleeve 8. When the detent element 4 is pulled out of the detent receiving means 7 (FIG. 6e) the sleeve 8 still forms the abutment for the resilient limbs 9. As the sleeve 8 is mounted displaceably on the stem 6 of the detent element 4, the detent element 4 can be withdrawn until the sleeve 8 bears against the detent tip 5, thereby preventing the free ends 11 of the resilient limbs being able to engage the stem 6 of the detent element 4, in a condition of embracing the detent tip 5. Upon further withdrawal movement of the detent element 4 the free ends of the resilient limbs 9 firstly slide over the peripheral surface of the sleeve 8 and subsequently over the detent tip 5 until, as shown in FIG. 6f, the snap connection is released again.

In a further alternative configuration of the snap connection 1 according to the invention, as shown in FIG. 7, the rigid member 3 is formed by the detent receiving means 7 while the resilient member 2 is formed by the detent element 4. The detent element 4 has a plurality of detent segments 21, 21′, of which each includes a portion of the detent tip 5 and a portion of the stem 6 of the detent element 4. In this arrangement the free ends 25, 25′ of the detent segments 21, 21′ are of a hook-shaped configuration. Mounted displaceably on the stem of the detent element 4 is a sleeve 8 which has casing segments 22, 22′, the free ends 24, 24′ of which are also of a hook-shaped configuration, wherein the outward sides of the free ends 24, 24′ have wedge surfaces which are at an angle relative to each other. On its side remote from the detent receiving means 7 the detent element 4 is connected to a clothes hook 19 by means of a screwthreaded bolt 23. Instead of the clothes hook 19 it would also be possible to connect everyday articles such as tools or domestic articles to the detent element 4.

FIG. 8 shows an exploded view of the embodiment of the invention as illustrated in FIG. 7, from which it will be seen that the detent receiving means 7 is formed by a bore in the rigid member 3 of the snap connection 1. That rigid member 3 can be formed for example by a wood, metal or plastic plate or the like, whereby, in contrast to the previously known state of the art, an article connected to a detent element according to the invention can be fixed in the simplest possible fashion to virtually any opening.

FIG. 10 shows an alternative embodiment of the detent receiving means 7 according to the invention. In this arrangement the detent receiving means 7 is formed by a shaped tube 26 which has a plurality of bores 27 and/or through openings 28, extending in the longitudinal direction, for detent elements.

FIGS. 9a to 9h show the procedure for making or releasing the snap connection according to the invention. Starting from FIG. 9a in which the detent receiving means 7 and the detent element 4 are out of engagement the detent element 4 is pressed into the detent receiving means 7 in the direction of the arrow. When the detent tip 5 passes into the detent receiving means 7 (9b) the radially movable detent segments 21, 21′ of the detent element 4 are pushed together, that is to say in the direction of the longitudinal axis of the detent element 4 until—as shown in FIG. 9c-the hooked free ends 25, 25′ of the detent element 4 have passed entirely through the detent receiving means 4 and in the course of the radial outward movement of the detent segments 21, 21′ come into engagement with the detent receiving means 7.

To release the snap connection (FIG. 9d) the detent element is pushed further into the detent receiving means 7 in the direction of the arrow until the free ends 24 of the casing segments 22 of the sleeve 8 have also passed through the detent receiving means 7 (FIG. 9e). To release the snap connection (FIG. 9f) the detent element 4 is pulled out of the detent receiving means 7 in the direction of the arrow. In that situation, as a result of the clamping action of the free ends 24 of the resilient casing segments 22 the sleeve 8 is displaced in the direction of the detent tip 5 until the hooked free ends 25, 25′ of the detent segments 21, 21′ of the detent element 4 come into positively locking engagement with the free ends 24 of the casing segments 22 of the sleeve 8, whereby, as shown in FIGS. 9f and 9g, the detent element 4 can be pulled out of the detent receiving means 7 without the hooked free ends 25, 25′ of the detent element 4 hooking on the detent receiving means 7 or coming into engagement therewith.

Further, at the time shown in FIG. 9g, the clamping action between the sleeve 8 and the detent segments 21 is removed as a consequence of the radial outward movement of the casing segments 22 so that the sleeve 8 slides back along the stem of the detent element 4 and the starting position shown in FIG. 9a is restored.

1. A releasable snap connection between an elastically resilient and a preferably rigid member, comprising a detent element having a stem and a detent tip, and a detent receiving means, wherein the detent element at least partially engages into the detent receiving means characterised in that the detent element (4) has a sleeve (8) mounted displaceably along its stem (6) for releasing the snap connection (1).

2. A snap connection according to claim 1 characterised in that for releasing the snap connection (1) the displaceable sleeve (8) can be moved into a position of releasing the resilient member (2) with respect to the rigid member (3) and remains in that position until the detent element (4) and the detent receiving means (7) are out of engagement.

3. A snap connection according to claim 1 or claim 2 characterised in that the one resilient member (2) of the snap connection (1) is formed by the detent receiving means (7) while the other, preferably rigid member (3) of the snap connection (1) is formed by the detent element (4).

4. A snap connection according to claim 3 characterised in that the detent receiving means (7) has at least one resilient limb (8) which is adapted for preferably positively lockingly embracing the detent tip (5) of the detent element (4).

5. A snap connection according to claim 3 or claim 4 characterised in that the stem (6) of the detent element (4) has a preferably annular, flange-like enlargement (10), wherein the sleeve (8) is arranged on the stem (6) displaceably between said flange-like enlargement (10) and the detent tip (5).

6. A snap connection according to claim 5 characterised in that the detent receiving means (7) has at least two resilient, preferably substantially I-shaped limbs (9, 9′), the free ends (11, 11′) of which are adapted for engagement between the detent tip (5) and the flange-like enlargement (10).

7. A snap connection according to one of claims 3 to 5 characterised in that on its side towards the detent tip (5) the sleeve (8) is of a conically tapered configuration and/or the free end or ends (11, 11′) of the limb or limbs (9, 9′) of the detent receiving means (7) is or are bevelled.

8. A snap connection according to one of claims 3 to 7 characterised in that the detent receiving means (7) is in the form of a shaped tube (12), preferably of a rectangular cross-sectional area, and has at least one through opening (13) extending in the longitudinal direction for the detent element or elements (4), wherein on at least one side of the through opening the wall of the tube (12) has a plurality of through apertures (14) which extend substantially normal to the through opening and which extend as far as the through opening.

9. A snap connection according to one of claims 3 to 8 characterised in that the detent receiving means (7) is mounted in a housing (15) with a through opening for the detent element (4), wherein the resilient limb or limbs (9, 9′) is or are supported on the housing (15) with its or their end or ends (11, 11′) embracing the detent tip (5) of the detent element (4).

10. A snap connection according to claim 9 characterised in that the housing (15, 16) is arranged displaceably in a shaped tube (17) with a through opening (17) extending in the longitudinal direction.

11. A snap connection according to claim 1 or claim 2 characterised in that the one resilient member (2) of the snap connection (1) is formed by the detent element (4) while the other, preferably rigid member (3) of the snap connection (1) is formed by the detent receiving means (7).

12. A snap connection according to claim 11 characterised in that the detent element (4) has at least two detent segments (21, 21′) which are of a radially resilient nature.

13. A snap connection according to claim 11 or claim 12 characterised in that at least one detent segment (21, 21′) includes a portion of the detent tip (5) and a portion of the stem (6) of the detent element (4).

14. A snap connection according to one of claims 11 to 13 characterised in that the sleeve (8) has at least two casing segments (22, 22′) which are of a radially resilient nature.

15. A snap connection according to one of claims 11 to 14 characterised in that the detent segments (21, 21′) of the detent element (4) and the casing segments (22, 22′) of the sleeve (8) are adapted for preferably positively locking engagement with each other.

16. A snap connection according to one of claims 11 to 15 characterised in that the free ends (25, 25′) of the detent segments (21, 21′) of the detent element (4) and/or the free ends (24, 24′) of the casing segments (22, 22′) of the sleeve (8) are hooked.

17. A snap connection according to one of claims 11 to 16 characterised in that the outer peripheral surface of the sleeve (8) is adapted for frictional engagement with the detent receiving means (7).

18. A snap connection according to one of claims 11 to 17 characterised in that the detent receiving means (7) is formed by a bore in the preferably rigid member (3) of the snap connection (1), for example in a wood, metal or plastic plate or the like.

19. A snap connection according to one of claims 11 to 18 characterised in that the detent receiving means (7) is in the form of a shaped tube (26) and has at least one bore (27) and/or at least one through opening (28) extending in the longitudinal direction, for a resilient detent element (4).
